(19) United States
(12) Patent Application Publication
(10) Pub. No.: US 2018/0022226 A1
(43) Pub. Date: Jan. 25, 2018

(54) METHOD AND CONTROL SYSTEM FOR CHARGING A VEHICLE

(71) Applicant: Scania CV AB, Södertälje (SE)

(72) Inventor: Robert Sjodin, Nyköping (SE)

(21) Appl. No.: 15/550,395

(22) PCT Filed: Feb. 18, 2016
(86) PCT No.: PCT/SE2016/050125

§ 371 Date: Aug. 11, 2017

(30) Foreign Application Priority Data
Feb. 18, 2015 (SE) 1550177-8

(51) Int. Cl. B60L 11/18

(52) U.S. Cl. CPC B60L 11/1838; B60L 11/1861; B60L 11/1818; B60L 2240/30; B60L 2250/16; B60L 2240/48; B60L 2240/44; B60L 2240/42; Y10S 903/903; B60Y 2200/92; B60Y 2300/91

(57) ABSTRACT

A hybrid vehicle and a method of controlling a hybrid vehicle is provided. The hybrid vehicle comprises an electronic control system configured to perform a first mode of controlling the selective opening and closing of a blocking mechanism of a connector socket, which connector socket is provided for connection of a charging cable to the hybrid vehicle. The first mode including: monitoring a respective state of two or more components of the hybrid vehicle, and automatically opening the blocking mechanism upon determining that said states of said two or more components fulfill a respective criterion. The two or more components include a parking brake, and vehicle locks, wherein the criteria for automatically opening the blocking mechanism include a state of the parking brake being applied, and a state of the vehicle locks being unlocked.

### CROSS-REFERENCE TO RELATED APPLICATION(S)

This application is a national stage application (filed under 35 §U.S.C. 371) of PCT/SE16/050125, filed Feb. 18, 2016 of the same title, which, in turn claims priority to Swedish Application No. 1550177-8, filed Feb. 18, 2015 of the same title; the contents of each of which are hereby incorporated by reference.

### FIELD OF THE INVENTION

The invention relates to a hybrid vehicle, and a method for controlling a hybrid vehicle, especially for preparing the hybrid vehicle for charging and prevent a vehicle from drive away or rolling away during the charging of the batteries of the vehicle.

### BACKGROUND OF THE INVENTION

During charging of the battery of a plug-in hybrid vehicle, or plug-in electric vehicle, it is important that the vehicle remains stationary and does not roll or drive away. This is especially important when a charging cable is connected to the vehicle.

In a normal situation when a plug-in hybrid vehicle should be charged, the driver parks the hybrid vehicle at a charging station, turns off the engine and connects the charging cable to the vehicle by inserting the plug of the charging cable into the charging socket of the hybrid vehicle. The hybrid system and the charging station starts to communicate and the hybrid system requests charging whereby the charging station starts to deliver electrical energy to the battery of the hybrid vehicle.

The driver would normally apply the parking brake when parking the hybrid vehicle.

GB-2501727-A ('727) describes a hybrid vehicle provided with a charging coupling (24, 25 in '727) comprising a reconfigurable blocking member (27 with “moving member 28” in '727) to prevent connection of a charging connector unless charging is intended. In this way unauthorized insertion can be prevented (see abstract of '727). When the transmission of the hybrid vehicle is enabled and the engine is running, the coupling is blocked. The coupling is unblocked in response to an input or command, for example from inside the vehicle, typically the drivers user interface (HMI, see page 2, line 14-21).

'727 provides a secure way of preventing unauthorized insertion into a charging coupling of the vehicle, and preventing insertion when the motor is running prevents drive away of the hybrid vehicle with a cable inserted into the coupling.

However, there are some disadvantages with the hybrid vehicle of '727, for example, the driver may forget to unblock the coupling and will be unable to insert a charging connector unless going back to the user interface inside the hybrid vehicle. Also, the arrangement of '727 does not prevent roll away of the hybrid vehicle during charging.

US 2010/0320964 ('964) describes a hybrid vehicle and a method for allowing or preventing insertion of a charging plug to the hybrid vehicle. The charging plug is allowed to be inserted when the hybrid vehicle is parked, which is determined when the parking brake is applied or the gear box is in a parked position, see §0006 and FIG. 7 of '964. Requiring that the parking brake is applied prevents roll away of the hybrid vehicle during charging. Charging is only allowed if some conditions are met. Moreover, if the hybrid vehicle cannot be charged, the hybrid vehicle can inform the driver why the charging does not occur. (see §0008-§0009 in '964).

### SUMMARY OF THE INVENTION

It is an object of the invention to provide a more secure and reliable way of ensuring that the hybrid vehicle remains stationary during the charging.

An object of the invention is also to provide an easy to use blocking mechanism of the charging cable connector of the hybrid vehicle.

A further object of the invention is to prevent unauthorized access to the coupling or charging socket when the vehicle is in use.

According to a first aspect, the invention provides a hybrid vehicle. The hybrid vehicle comprises an electronic control system including a hybrid system controller, and a hybrid system comprising a connector for connection of a charging cable of a charging station to the hybrid vehicle. The connector comprises a blocking mechanism for selectively preventing and allowing access of a charging cable plug to the connector. The blocking mechanism preferably comprises a blocking member that is movable between a closed position and an open position for selectively preventing and allowing insertion of a plug of the charging cable into the connector. The electronic control system is operatively connected to the blocking mechanism and is connected to a number of components of the hybrid vehicle, wherein said electronic control system is configured to perform a first mode of controlling a selective opening and closing of the blocking mechanism. Especially, the electronic control system is configured, when performing the first mode, to:

determine the state of two or more components of the hybrid vehicle; and

automatically open the blocking mechanism upon determining that a state of each of said two or more components fulfills a respective criterion, wherein said two or more components include:
the parking brake, wherein the criteria for automatically opening the blocking mechanism include that the state of the parking brake is applied; and
the vehicle locks, wherein the criteria for automatically opening the blocking mechanism include that the state of the vehicle locks are unlocked.

Thus, the invention facilitates charging of the hybrid vehicle by automatically opening the blocking mechanism when determining that the parking brake is applied and the vehicle locks are unlocked, which indicates that the hybrid vehicle has been parked for charging, and also prevents rolling away of the hybrid vehicle during a subsequent charging process. It is easy to use, since a driver does not have to make any input to the hybrid vehicle, only avoiding to lock the hybrid vehicle.

If the driver parks the hybrid vehicle, and intends not to charge the hybrid vehicle, but to leave it, the driver would normally lock the hybrid vehicle.

When driving the hybrid vehicle, the blocking mechanism would not be open, since the parking brake is not applied.

In addition to using the criterion that state of the parking brake is applied, the embodiments use further indications of whether the driver has parked or is driving the hybrid vehicle.

In an embodiment of the first aspect, said two or more components include the gear box and the criteria for automatically opening the blocking mechanism include that the state of the gear box is the neutral gear.

An advantage of determining that the gear box is in neutral is that this criterion gives a further indication that the hybrid vehicle has been parked and also has the advantage of preventing drive away of the hybrid vehicle during a subsequent charging process.

In an embodiment of the first aspect, said two or more components includes the internal combustion engine and the criteria for automatically opening the blocking mechanism includes that the state of the internal combustion engine is off.

An advantage of determining that the internal combustion engine is off is that this criterion gives a further indication that the hybrid vehicle has been parked and also has the advantage of preventing drive away of the hybrid vehicle during a subsequent charging process.

In an embodiment of the first aspect, said two or more components include the electric motor and the criteria for automatically opening the blocking mechanism include that the state of the electric motor is disabled.

An advantage of determining that the electric motor is disabled is that this criteria gives a further indication that the hybrid vehicle has been parked and also has the advantage of preventing drive away of the hybrid vehicle during a subsequent charging process.

In an embodiment of the first aspect, said two or more components includes the ignition switch and wherein the criteria for automatically opening the blocking mechanism include that the state of the ignition switch is either on or off, that is, not in cranking.

In an embodiment of the first aspect, the electronic control system is configured to:

detect insertion of a plug into the connector when performing the first mode;

switch to a second mode of controlling the blocking mechanism upon detecting the plug; and

secure the plug to the connector by closing the blocking mechanism when performing the second mode.

Thus, the blocking mechanism is configured to secure, or lock, a charging plug, preferably by means of the blocking member, in addition to selectively prevent and allow access to the charging connector.

An advantage of locking, or securing, the plug of the charging cable to the connector is that locking prevents unauthorized or accidental removal of the plug during a subsequent charging of the hybrid vehicle.

The electronic control system is configured to perform the second mode of controlling the blocking mechanism and charge the hybrid vehicle while being in the second mode.

In an embodiment of the first aspect, the electronic control system is configured to lock the parking brake in the applied state when performing the second mode.

Locking the parking brake is advantageous since it ensures even further that the hybrid vehicle remains stationary during charging by preventing roll away of the hybrid vehicle.

In an embodiment of the first aspect, the electronic control system is configured to lock the gear box in the neutral gear when performing the second mode.

Locking the gear box is advantageous since it ensures even further that the hybrid vehicle remains stationary during charging by preventing roll away of the hybrid vehicle.

In an embodiment of the first aspect, the electronic control system is configured to request charging when performing the second mode.

Preferably, the electronic control system is configured to request charging after both the parking brake and the gear box has been locked. After switching to the second mode, the electronic control system is preferably configured to ensure that the hybrid vehicle is ready for charging by locking the parking brake and locking the gear box before requesting charging. Preferably, the electronic control system is configured to release the plug when the charging process ends.

In an embodiment of the first aspect, the electronic control system is configured to allow start of the internal combustion engine when performing the second mode.

According to a second aspect, the present invention provides a method of controlling a hybrid vehicle, which method is performed by an electronic control system of the hybrid vehicle. The hybrid vehicle includes a hybrid system comprising a connector for connection of a charging cable of a charging station to the hybrid vehicle. The electronic control system of the hybrid vehicle preferably comprises a hybrid system controller. The connector comprises a blocking mechanism for selectively preventing and allowing insertion of a plug of the charging cable into the connector. The method is performed by the electronic control system and includes a first mode of controlling the blocking mechanism. Especially, the first mode includes:

monitoring the state of two or more components of the hybrid vehicle; and

automatically opening the blocking mechanism upon determining that the state of said two or more components fulfills a respective criterion, wherein said two or more components include the parking brake and the vehicle locks, wherein the criteria for automatically opening the blocking mechanism include that the state of the parking brake is applied, and that the state of the vehicle locks are unlocked.

In an embodiment of the second aspect of the invention, said two or more components include the gear box and the criteria for automatically opening the blocking mechanism include that the state of the gear box is the neutral gear.

In an embodiment of the second aspect of the invention, said two or more components include the internal combustion engine and the criteria for automatically opening the blocking mechanism includes that the state of the internal combustion engine is off.

In an embodiment of the second aspect of the invention, said two or more components include the electric motor and wherein the criteria for automatically opening the blocking mechanism includes that the state of the electric motor is disabled.

In an embodiment of the second aspect of the invention, said two or more components include the ignition switch and wherein the criteria for automatically opening the blocking mechanism include that the state of the ignition switch is either on or off.

In an embodiment of the second aspect of the invention, the method further includes detecting insertion of a plug of a charging station in the connector and switching to a second mode of controlling the blocking mechanism upon detecting the plug, which second mode of controlling the blocking mechanism includes securing the plug in the connector by closing the blocking mechanism.

In an embodiment of the second aspect of the invention, the second mode includes ensuring that the hybrid vehicle is ready for charging by locking the parking brake in the applied state.

In an embodiment of the second aspect of the invention, the second mode includes ensuring that the hybrid vehicle is ready for charging by locking the gear box in the neutral gear.

In an embodiment of the second aspect of the invention, the second mode includes requesting charging.

In an embodiment of the second aspect of the invention, the plug is released when the charging process ends.

In an embodiment of the second aspect of the invention, the second mode includes releasing the plug by opening the blocking mechanism when at least one of the following three criteria is fulfilled:

the state of the vehicle locks is changed from locked to unlocked;

a command indicating that charging should be stopped is received from a user interface of the hybrid vehicle; or

a state of an energy storage of the hybrid vehicle (1) reaches fully loaded.

According to a third aspect, the present invention provides a computer program product comprising a computer program that is loadable into a memory of an electronic control system of a hybrid vehicle, and which computer program upon execution in the electronic control system, for example a hybrid controller of the electronic control system, enables the electronic control system to perform the method of controlling charging of the hybrid vehicle, as described above and as will be further described in the following description of embodiments.

### BRIEF DESCRIPTION OF DRAWINGS

The invention will be described, by way of example, with reference to the accompanying drawings, in which:

FIG. 1 is a schematic flow chart illustrating embodiments of a method of controlling a hybrid vehicle;

FIG. 2 is a schematic illustration of an embodiment of a hybrid vehicle at a charging station; and

FIG. 3 illustrate some further details of the hybrid vehicle and charging station of FIG. 2.

### DETAILED DESCRIPTION OF THE INVENTION

The invention will in the following be described with reference to the accompanying drawings, in which certain embodiments of the invention are illustrated. The invention may however be embodied in many different forms and should not be construed as limited to the embodiments; rather, these embodiments are provided by way of example in order to facilitate in making the invention.

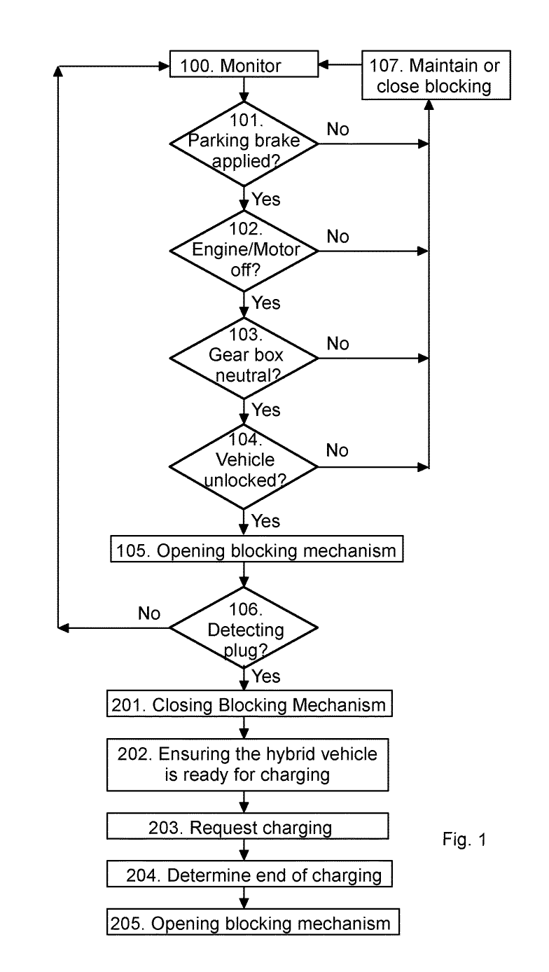

FIG. 1 illustrates embodiments of the method of controlling a hybrid vehicle according to the invention. In a representative scenario when a hybrid vehicle should be charged, a driver of the hybrid vehicle parks the hybrid vehicle at a charging station, applies the parking brake, sets the gear box in neutral, turns off the engine and inserts a plug of a charging cable into the charging socket of the hybrid vehicle.

The method of controlling a hybrid vehicle illustrated in FIG. 1 comprises controlling a blocking mechanism of a charging socket of the hybrid vehicle. The method is performed by the electronic control system of the hybrid vehicle. The blocking mechanism is controlled in accordance with a first mode of operation when the hybrid vehicle is used, i.e. not during charging. The first mode of operation includes monitoring 100 components of the hybrid vehicle, evaluating the state of two or more components, in steps 101-104, and opening 105 the blocking mechanism for insertion of a charging plug of an external charging station, when the states indicate that charging should be performed. The first mode of operating the blocking mechanism ends with detecting 106 insertion of a charging plug, whereafter the method switch to a second mode of operating the blocking mechanism by closing 201 the blocking mechanism and thereby prevent removal of the inserted charging plug. The user may then lock the hybrid vehicle. After switching to the second mode of operating the blocking mechanism, the method of controlling the hybrid vehicle comprises ensuring 202 that the hybrid vehicle is ready for charging, and subsequently initiating a charging process by requesting charging 203 from the external charging station. The method ends by releasing 204 the plug of the charging cable when the charging process ends. The method may include a step of ending the charging process when the energy storage is fully loaded, when the user inputs a command indicating that the charging process should be ended, or when the user unlocks the vehicle locks.

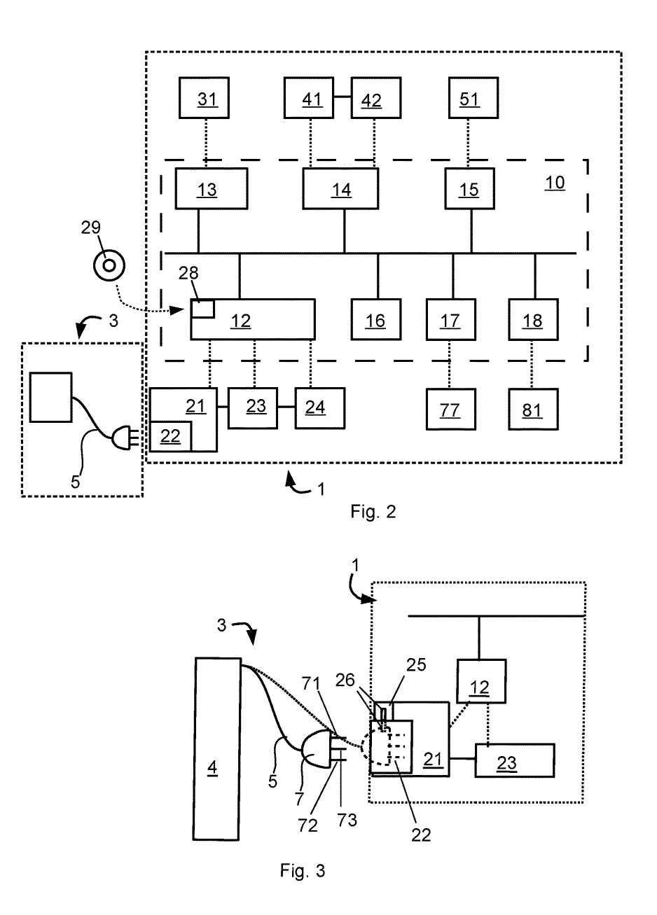

FIG. 2 illustrates a hybrid vehicle 1 at a charging station 3. FIG. 2 is an overview of parts of a control system 10 of a hybrid vehicle 1, such as comprising a CAN communication network and comprising a plurality of control units 12-18, such as ECU (Electronic Control Units). The control units are interconnected and includes a hybrid controller 12, an engine control system 13, a parking brake controller 14, a gear box controller 15, a user interface 16, an ignition switch 17 and a central locking system 18. The charging station 3 comprises a charging cable 5 adapted for transferring electrical energy to, and provide communication with, the hybrid vehicle 1.

Each control unit 12-18 is configured to control respective units of the vehicle 1 and in the following features relevant for describing the invention will be described in more detail, although FIG. 2 as such is a simplified illustration of a control system 10 of a hybrid vehicle 1.

The hybrid controller 12 is operatively connected to hybrid system comprising a charging unit 21, a battery system or energy storage 23 and an electronic motor system 24. The hybrid controller 12 is configured to monitor and control the charging unit 21 during charging of the vehicle, and detect connection of a charging cable 5 to a cable connector socket 22 of the charging unit 21 and is also configured to request charging of the hybrid vehicle 1 from a charging station 3. The hybrid controller 12 is also configured monitor the charging level of the battery system or energy storage 23. The hybrid controller 12 is provided with a stay awake function that allows the hybrid controller 12 to stay awake when the ignition is switched off. The hybrid controller 12 is configured to wake-up other control units, of the control units 13-18, in the electric control system 10 in order to perform its functions when controlling the charging of the hybrid vehicle 1.

FIG. 3 illustrates the charging unit 21 in more detail. A mechanical blocking mechanism 25 is arranged at the connector socket 22. The mechanical blocking mechanism 25 is arranged to selectively a) allow access to the charging socket 22 and b) prevent access to the socket 22. The mechanical blocking mechanism 25 includes a blocking member 26 movable between a position outside the connector socket 22 and a position inside the connector socket, wherein access to the socket 22 is prevented or, in case a charging plug 7 has been inserted, wherein the charging plug 7 is locked to the connector socket 22. Maneuvering of the blocking mechanism 25 is electronically controlled. Especially, the electronic control system 10, preferably the hybrid system controller 12, is configured to control the blocking mechanism 25 and thus control access, i.e. connection, of a charging cable 5 to the charging socket 22. The electronic control system 10 is configured to selectively apply the blocking mechanism 25 or open the mechanical blocking member 25 in dependence of the state of the hybrid vehicle 1. Especially, the hybrid controller 12 of the electronic control system 10 is configured to selectively open and closing the blocking mechanism 25 in dependence of the state of a number of components (17, 31, 41, 42, 51, 23, 24, 81 in FIG. 1) of the hybrid vehicle 1. For this purpose the hybrid controller 12 monitors the state of these components 17, 31, 41, 42, 51, 81, 23, 24 by means of the corresponding control units 12-17.

FIG. 2 illustrates the components of the hybrid vehicle 1, which comprises an internal combustion engine 31, a parking brake 41, a gear box 51, a start/stop button 77, vehicle locks 81 and a user interface 16.

The engine control system 13 is configured control the internal combustion engine 31 and is especially configured to monitor the status of the internal combustion engine 31 being on or off. The engine control system 13 is operatively configured to start and stop the engine upon receiving user input from the user interface 16 indicating starting and stopping, respectively. The engine control system 13 also includes an idle start/stop function and be adapted to stop and start the internal combustion engine 31 in order to save fuel by using the electric motor 24. Such an idle start/stop function is known in the art and is not disclosed further in this description. For the purposes of the invention, the engine control system 13 is adapted to indicate whether such an idle start/stop function is activated in the hybrid vehicle 1, in order to prevent concluding that the internal combustion engine 31 is turned off by the driver in cases when it is the idle start/stop-function that has turned off the engine 31.

The parking brake controller 14 is connected to the parking brake system and is configured to monitor the status of the parking brake 41. Preferably, the parking brake is manually activated and pneumatically driven by means of a pneumatic drive system 42. The parking brake controller 14 is configured to monitor the state of the parking brake 41. The parking brake is preferably an electronic parking brake, and the parking brake controller 14 is configured to control the parking brake, and lock the parking brake electronically.

The gear box controller 15 is operatively connected to the gear box 51 and is configured to monitor the state of the gear box, especially which gear is active. The electronic control system 10 is configured to monitor whether the gear box 51 is in neutral or not, and only allow removal of the blocking mechanism 25 when the gear box 51 is in neutral. The monitoring of the gear box 51 can be provided by the hybrid controller 12 in cooperation with the gear box controller 15, wherein the hybrid controller 12 is suitable configured to maneuvering the blocking mechanism 25 based on the state of the gear box 51, i.e. only allowing access when the gear box 51 is in the neutral when performing the first mode of operation. The hybrid controller 12 is suitably configured to lock the gear box 51 in the neutral, by means of the gear box controller 15, before requesting charging.

The user interface 16 is configured to receive user input from the driver, such as the driver turning on and off the main internal combustion engine, such as a diesel, an ethanol or a gas engine, or the driver stopping charging of the hybrid vehicle 1.

The ignition switch 17 is configured to monitor the start/stop button 77 for turning on and off the ignition of the hybrid vehicle, and selectively switch on or off the ignition based on the input received from the user via the start/stop button. An ignition key-lock may be used as an alternative to the start/stop button 77. The hybrid controller 12 is configured to monitor the state of the ignition switch 17. The hybrid controller 12 is provided with a stay awake function that allows the hybrid controller 12 to stay awake when the ignition is switched off. The hybrid controller 12 is configured to wake-up other control units in the electric control system 10 in order to perform its functions when controlling the blocking mechanism 25 and charging the hybrid vehicle 1 in accordance with the method described.

The central locking system 18 is configured to control the vehicle locks 81. The central locking system 18 is configured to lock and unlock the vehicle locks 81. The hybrid controller 12 is configured to monitor the state of the vehicle locks when controlling the blocking mechanism 25. The central locking system 18 may be any kind of known vehicle locking system that locks and unlocks the vehicle locks 81 for example when receiving input from a user maneuvering a key, an electronic key or “keyless” electronic device, and/or in response to signals retrieved using for example RFID technology.

In the first mode of operation, the electronic control system 10, e.g. the hybrid system controller 12, is adapted to open the mechanical blocking mechanism 25 when:

the parking brake 41 is applied;

the vehicle locks 81 are unlocked;

the gear box 51 is in neutral;

the ignition switch 17 is either on or off, that is, not cranking;

the internal combustion engine 31 is turned off; and

the idle start/stop function of the engine control system 13 is not activated.

As is further illustrated in FIG. 3, the charging station 3 comprises a supply unit 4 for supplying electrical energy to the hybrid vehicle 1. The supply unit 4 has the outer form of a pole, which is secured to the ground and remains stationary during charging. The supply unit 4 is connected to an electrical power system (not illustrated). The charging station 3 further comprises a charging cable 5 provided with a charging plug 7 provided for insertion into a hybrid vehicle 1. The charging cable 5 and charging plug 7 provides a movable link between the supply unit 4 and the hybrid vehicle 1 and is provided to transfer the electrical energy to energy storage 23 of the hybrid vehicle 1.

The charging cable socket 22 of the hybrid vehicle 1 is configured for receiving the charging plug 7 of the charging station 3. As in FIG. 2, the hybrid vehicle 1 also comprises a hybrid controller 12 and an energy storage 23 that comprises batteries. The energy storage 23 is provided with an electrical connection to the charging unit 21, and the hybrid vehicle 1 is configured to receive electrical energy by means of the charging unit 21, which energy is stored in the energy storage 23. The hybrid controller 12 is adapted to control and monitor the charging unit 21 and the energy storage 23, in order to control the charging process.

The charging plug 7 of the charging station 3 comprises a number of contact pins, exemplified as three contact pins 71-73. The number of contact pins may be chosen differently. The three contact pins 71-73 are configured to provide three functions. The charging cable socket 22 of the hybrid vehicle 1 is provided with corresponding contacts in order to establish a connection with the contact pins 71-73 of the charging station 3.

A first contact pin 71 is a presence indicating pin, which is arranged to indicate a presence of the plug in the hybrid vehicle when the charging plug 7 is inserted into the socket 71. The hybrid controller 12 is configured to detect the presence of a charging plug 7 in the cable socket 22.

A second contact pin 72 is arranged to provide contact for a communication interface between the charging station 3 and the hybrid controller 12 of the hybrid vehicle 1. Upon insertion of the charging plug 7 in the socket of the hybrid vehicle 1, the hybrid vehicle 1 is configured to detect the presence of the charging plug 7, and to initiate a communication session with the charging station 3 by means of the hybrid controller 12 via the charging unit 21 and the connection between the second contact pin 72 and the corresponding contact of the socket 22.

The hybrid controller 12 is further configured to perform a handshaking session with the charging station 3 upon connection of the charging cable 5.

When detecting insertion of the charging plug 7, the electronic control system 10, especially the hybrid controller 12, is configured to switch to the second mode of operating the blocking mechanism 25. The second mode of operation starts with closing the blocking mechanism 25, by moving the blocking member 26 to a position inserted in the charging plug 7.

The third contact pin 73 of the charging station 3 is provided for the transfer of the electrical energy to the energy storage 23, via the charging unit 21 and the corresponding contact of the socket 22 of the charging unit 21. The hybrid controller 12 is configured to request charging from the charging station 3 when the hybrid vehicle 1 is ready for charging. Thus, the electronic control system 10, especially the hybrid controller 12, is configured to ensure that the hybrid vehicle 1 is ready for charging and request charging when operating in the second mode of controlling the blocking mechanism 25, which includes keeping the blocking mechanism 25 closed.

The hybrid controller 12 is configured to ensure that the hybrid vehicle 1 is ready to be charged by monitoring the state of the hybrid vehicle 1, and to request charging by means of the communication interface, wherein the charging station 3 starts the supply of electrical energy.

Thus, the hybrid vehicle 1 is configured to:

operate in a first mode of controlling the blocking mechanism 25 which include:

monitor the state of the hybrid vehicle 1 and selectively open and close the blocking mechanism 25 in dependence of the state;

receive and detect the presence of the plug 7 in the socket 22;

establish communication with the charging station 3; and

lock the charging plug 7 in the socket 22.

The hybrid vehicle 1 is further configured to:

operate in a second mode of controlling the blocking mechanism 25 which include:

keep the charging plug 7 secured, or locked, in the socket 21;

ensure that the hybrid vehicle 1 is ready for charging;

request charging from the charging station 3;

store the received electrical energy in the energy storage 23; and

release the charging plug 7 by opening the blocking mechanism 25 when the charging process ends.

The charging process is preferably ended when the energy storage 23 is fully loaded, as detected by the hybrid controller 12, or when the driver ends the process by means of a inputting a command using the user interface 16.

FIG. 1 illustrates the first mode and the second mode of the control method in more detail.

The first mode includes monitoring 100 the state of the hybrid vehicle 1, including monitoring the state of a number of components.

The first mode of operating the blocking mechanism comprises determining 101 the state of the parking brake 41. If the state of the parking brake 41 is released, the method continues with keeping the blocking mechanism 25 closed or closing 107 the blocking mechanism 25, and continues monitoring 100 the components of the hybrid vehicle 1.

If the state of the parking brake 41 is applied, the method continues with determining 102 the state of the internal combustion engine 31 and the electric motor 24. If the internal combustion engine 31 is running or the electric motor 24 is active, the method keeps the blocking mechanism closed or continues with closing 107 the blocking mechanism 25, and continues the monitoring 100.

If the internal combustion engine 31 is not running and the electric motor 24 is disabled, the method continues with determining 103 the state of the gear box 51.

In case the hybrid vehicle 1 is provided with an idle start/stop function in the engine control system 13, the determining 102 of the state of the internal combustion engine 31 includes determining if the start/stop function is active, in which case the method returns to keeping the blocking mechanism 25 closed or closing 107 the blocking mechanism 25.

Thus, if the parking brake 42 is applied, the electric motor 24 is disabled, the internal combustion engine 31 is not running and an idle start/stop function is not active, the method continues with determining 103 the state of the gear box 51.

In addition to, or as an alternative to, determining 102 the state of the internal combustion engine 31 and the electric motor 24, the method can include determining the state of the ignition switch 17, i.e. determine if the ignition is on, off or cranking. If the state of the ignition switch is in cranking, the method keeps the connector 22 closed 107, and continues the monitoring 100. If the ignition switch 17 is on or off the method continues with determining 103 the state of the gear box 51.

If the state of the gear box 51 is not the neutral, i.e. the gear box 51 is in another gear than the neutral gear, the method returns to keeping the blocking mechanism 25 closed, or closing 107 the blocking mechanism 25, and thus returns and continues monitoring 100 the state of the components of the hybrid vehicle.

If the state of the gear box 51 is in the neutral, the method continues with opening 105 the blocking mechanism 25.

The method continues with monitoring 106 the connector socket 22, especially determining if the first contact pin 71 can be detected, and determines whether a charging plug 7 has been inserted or not. If no plug 7 is inserted, the method continues with monitoring 100 the state of the components of the hybrid vehicle 1. If any of state of the components has changed in steps 101, 102, 103, 104 and the criteria for opening the blocking mechanism 25 is not fulfilled, the method continues with closing 107 the blocking mechanism 25. Otherwise, as long as all the criteria for opening the blocking mechanism 25 is fulfilled, the method continues with keeping the blocking mechanism 25 open and awaits detection 106 of insertion of the charging plug 7.

When a charging plug 7 is inserted, the method continues with switching to the second mode of operating the blocking mechanism 25 and closes 201 the blocking mechanism 25 so that the charging plug 7 is kept in the connector socket 22.

The method continues with requesting charging 203, but preferably includes ensuring 202 that the hybrid vehicle 1 is ready for charging, so that charging can be performed in a safe and secure manner.

The ensuring 202 that the hybrid vehicle is ready for charging is performed while keeping the blocking mechanism 25 closed in accordance with the second mode of operation. The ensuring 202 that the vehicle is ready for charging suitable also includes a number of sub-steps. Each sub-step provides criteria that the hybrid controller 12 is configured to fulfil. The sub-steps include locking the gear box 51 in neutral, and locking parking brake 41 in the applied state. All of which sub-steps is performed prior to requesting 203 charging.

Preferably, the ensuring 202 that the hybrid vehicle is ready for charging includes at least one of the steps of:

locking the parking brake 41 in the applied state; and

locking the gear box 51 in the neutral gear.

The parking brake 41 and the gear box 51 are electronically locked by means of a respective inhibiting signal in the electronic control system 10, preferably set by the hybrid controller 12. The respective inhibiting signals indicate that release of the parking brake 41 is not allowed and that maneuvering of the gear box 51 is not allowed.

After ensuring 202 that the hybrid vehicle 1 is ready for charging, the method continues with requesting 203 charging of the hybrid vehicle 1. The blocking mechanism 25 is kept closed until the charging process ends.

The charging process ends when the charging level of the battery storage reach a predefined level, such as fully charged, or when the driver ends the charging process, for example by means of the user interface 16.

In the illustrated embodiment, the method includes determining 204 that the charging process should be ended. The determining that the charging process should be ended is based on at least one of the following criteria:

the energy storage (23) has been fully loaded;

the user stops the charging process by means of the user interface (16), wherein the user input a stop charging command; and

the state of the vehicle locks (81) changes from locked to unlocked, e.g. the user opens the hybrid vehicle (1) by means of an ordinary key or an electronic key.

When the charging process ends, the method ends by releasing 205 the plug 7 of the charging cable 5.

FIG. 2 also illustrates a computer program product 29, illustrated as a computer disc, which computer program product comprises a data carrier having a computer program stored thereon. The data carrier may be any non-transitory entity or device capable of carrying the program. For example, the data carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-Only Memory), or a magnetic recording medium, for example a floppy disc or hard disc. Alternatively, the carrier may be an integrated circuit in which the program is embedded, the integrated circuit being adapted for performing, or for use in the performance of, the relevant processes. The computer program is adapted for loading into a memory 28 of the electronic control system 10, and the computer program comprises software configured to be executed in the electronic control system 10 of the hybrid vehicle 1. The computer program is adapted to enable the electronic control system 10 to perform its functions, and especially the method steps described with reference to FIG. 1 when executed by the electronic control system 10.

A hybrid vehicle and a method of controlling a hybrid vehicle (1) has been described in embodiments with reference to the figures. The hybrid vehicle comprises an electronic control system (10) configured to perform a first mode of controlling the selective opening and closing of a blocking mechanism (25) of a connector socket (22), which connector socket (22) is provided for connection of a charging cable (5) to the hybrid vehicle. The first mode includes monitoring (100) the state of two or more components of the hybrid vehicle (1), and automatically opening (105) the blocking mechanism (25) upon determining (101, 102, 103, 104) that the state of said two or more components fulfill a respective criteria. Especially, the two or more components include the parking brake (41), and the vehicle locks (81), wherein the criteria for automatically opening (105) the blocking mechanism (25) includes that the state of the parking brake (41) is applied, and that the state of the vehicle locks (81) are unlocked. The present invention is however not limited to the described embodiments and may be varied within the scope of the claims.

The inventive concept is also applicable to a battery electric vehicle, BEV.

The inventive concept is also applicable for controlling a battery electric vehicle, which battery electric vehicle comprises an electronic control system including a drive system controller, and a drive system, which drive system comprises a connector for connection of a charging cable of a charging station to the hybrid vehicle, said connector comprising a blocking mechanism for selectively preventing and allowing insertion of a plug of the charging cable into the connector, said controlling being performed by the electronic control system and includes a first mode of controlling the blocking mechanism, and is characterized in that the first mode includes:

monitoring the state of two or more components of the battery electric vehicle; and

automatically opening the blocking mechanism upon determining that the state of said two or more components fulfills a respective criterion, wherein said two or more components include:

a parking brake, wherein the criteria for automatically opening the blocking mechanism includes that the state of the parking brake is applied; and

the vehicle locks, wherein the criteria for automatically opening the blocking mechanism include a state of the vehicle locks being unlocked.

1. A hybrid vehicle, comprising an electronic control system including a hybrid system controller, and a hybrid system, which hybrid system comprises a connector for connection of a charging cable of a charging station to the hybrid vehicle, said connector comprising a blocking mechanism for selectively preventing and allowing access of a charging cable plug to the connector, said electronic control system being operatively connected to the blocking mechanism and being connected to a number of components of the hybrid vehicle, wherein said electronic control system being configured to perform a first mode of controlling the selective opening and closing of the blocking mechanism, wherein the electronic control system when performing the first mode of controlling is configured to:
determine the state of two or more components of the hybrid vehicle; and
automatically open the blocking mechanism upon determining that the state of each of said two or more components fulfills a respective criterion,
wherein said two or more components include:
a parking brake, wherein the criteria for automatically opening the blocking mechanism include a state of the parking brake being applied; and
vehicle locks, wherein the criteria for automatically opening the blocking mechanism include a state of the vehicle locks being unlocked.

2. The hybrid vehicle according to claim 1, wherein said two or more components include the gear box and wherein the criteria for automatically opening the blocking mechanism include a state of the gear box being in a neutral gear.

3. The hybrid vehicle according to claim 1, wherein said two or more components include an internal combustion engine and wherein the criteria for automatically opening the blocking mechanism include a state of the internal combustion engine being off.

4. The hybrid vehicle according to claim 1, wherein said two or more components include an electric motor and wherein the criteria for automatically opening the blocking mechanism include a state of the electric motor being disabled.

5. The hybrid vehicle according to claim 1, wherein said two or more components include an ignition switch and wherein the criteria for automatically opening the blocking mechanism include a state of the ignition switch being either on or off.

6. The hybrid vehicle according to claim 1, wherein the electronic control system is further configured to:
detect insertion of a plug into the connector when performing the first mode;
switch to a second mode of controlling the blocking mechanism upon detecting an inserted plug; and
secure the plug by closing the blocking mechanism when performing the second mode.

7. The hybrid vehicle according to claim 6, wherein the electronic control system is configured to:
lock the parking brake in the applied state when performing the second mode.

8. The hybrid vehicle according to claim 6, wherein the electronic control system is configured to:
lock the gear box in the neutral gear when performing the second mode.

9. The hybrid vehicle according to claim 6, wherein the electronic control system is configured to:
request charging when performing the second mode.

10. The hybrid vehicle according to claim 6, wherein the electronic control system is configured to:
lock the parking brake in the applied state when performing the second mode;
lock the gear box in the neutral gear when performing the second mode; and
request charging after the parking brake and the gear box have been locked.

11. The hybrid vehicle according to claim 6, wherein the electronic control system is configured to:
release the plug by opening the locking mechanism when performing the second mode, said plug being released when
the state of the vehicle locks changes from locked to unlocked;
a command indicating that charging should be stopped is received from a user interface of the hybrid vehicle; or
a state of an energy storage of the hybrid vehicle reaches fully loaded.

12. A method for controlling a hybrid vehicle, which hybrid vehicle comprises an electronic control system including a hybrid system controller, and a hybrid system, which hybrid system comprises a connector for connection of a charging cable of a charging station to the hybrid vehicle, said connector comprising a blocking mechanism for selectively preventing and allowing insertion of a plug of the charging cable into the connector, said method being performed by the electronic control system and includes a first mode of controlling the blocking mechanism, and wherein the first mode includes:
monitoring the state of two or more components of the hybrid vehicle; and
automatically opening the blocking mechanism upon determining that the state of said two or more components fulfills a respective criterion, wherein said two or more components include:
a parking brake, wherein the criteria for automatically opening the blocking mechanism includes that the state of the parking brake is applied; and
the vehicle locks, wherein the criteria for automatically opening the blocking mechanism include a state of the vehicle locks being unlocked.

13. The method for controlling a hybrid vehicle according to claim 12, wherein said two or more components include the gear box and wherein the criteria for automatically opening the blocking mechanism include a state of the gear box being in a neutral gear.

14. The method for controlling a hybrid vehicle according to claim 12, wherein said two or more components include an internal combustion engine and wherein the criteria for automatically opening the blocking mechanism include a state of the internal combustion engine being off.

15. The method for controlling charging according to claim 12, wherein said two or more components include an electric motor and wherein the criteria for automatically opening the blocking mechanism include a state of the electric motor being disabled.

16. The method for controlling charging according to claim 12, wherein said two or more components include an ignition switch and wherein the criteria for automatically opening the blocking mechanism include a state of the ignition switch being either on or off.

17. The method for controlling charging according to claim 12, further including detecting insertion of a plug of a charging station in the connector and switching to a second mode of controlling the blocking mechanism upon detecting an inserted plug, which second mode of controlling the blocking mechanism includes securing the plug in the connector by closing the blocking mechanism.

18. The method for controlling charging according to claim 17, wherein the second mode includes:
ensuring that the hybrid vehicle is ready for charging by locking the parking brake (42) in the applied state.

19. The method for controlling charging according to claim 17, wherein the second mode includes:
ensuring that the hybrid vehicle is ready for charging by locking the gear box in the neutral gear.

20. The method for controlling charging according to claim 16, wherein the second mode includes:
requesting charging.

21. The method for controlling charging according to claim 16, wherein the second mode includes:
releasing the plug by opening the blocking mechanism when at least one of the following three criteria is fulfilled:
the state of the vehicle locks being changed from locked to unlocked;
a command indicating that charging should be stopped being received from a user interface of the hybrid vehicle; or
a state of an energy storage of the hybrid vehicle reaching fully loaded.

22. A computer program product comprising computer program code stored in a non-transitory computer-readable medium readable by a computer, said computer program product used for controlling a hybrid vehicle, which hybrid vehicle comprises an electronic control system including a hybrid system controller, and a hybrid system, which hybrid system comprises a connector for connection of a charging cable of a charging station to the hybrid vehicle, said connector comprising a blocking mechanism for selectively preventing and allowing insertion of a plug of the charging cable into the connector, said computer program code comprising computer instructions to cause one or more computer processors to perform the following operations in a first mode of controlling the blocking mechanism:
monitoring the state of two or more components of the hybrid vehicle; and
automatically opening the blocking mechanism upon determining that the state of said two or more components fulfills a respective criterion, wherein said two or more components include:
a parking brake, wherein the criteria for automatically opening the blocking mechanism includes that the state of the parking brake is applied; and
the vehicle locks, wherein the criteria for automatically opening the blocking mechanism include a state of the vehicle locks being unlocked.
